(19) United States
(12) Patent Application Publication
(10) Pub. No.: US 2008/0046915 A1
(43) Pub. Date: Feb. 21, 2008

(54) System and method of providing community content

(75) Inventors: Anthony A. Haeuser, Aurora, IL (US); Mary McCarthy, San Antonio, TX (US); Scott Pettit, San Antonio, TX (US); Roland Noll, San Antonio, TX (US); John McClenny, San Antonio, TX (US)

Correspondence Address: TOLER LAW GROUP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/497,540

(22) Filed: Aug. 1, 2006

(51) Int. Cl. H04N 7/16; H04N 7/167

(52) U.S. Cl. 725/25; 725/31

(57) ABSTRACT

The present disclosure is directed to a system and method for providing community content. The method can include making content received from a first user via a data network available to a second user via a video distribution service. The system can include a selective transmission and filtering module to control transmission of content between an interface to a public data network and a private video distribution system.

### BACKGROUND

Television is a primary source of information for many households. Information such as national and local news is commonly available from broadcast television programming. Television service providers such as cable and satellite companies often offer enhanced community information such as a local government access channel. However, the available community information is determined by the scheduled programming and may not be of particular interest to some members of a community. For example, some viewers may prefer to watch a city counsel meeting, while others may prefer a high school football game.

The Internet offers an alternative source for many types of community information. Information may be published to websites so that interested Internet users may access the websites at their convenience. Unfortunately, publishers of information on the Internet face the difficult task of being locatable by people seeking the information. Publishers of community content often receive minimal financial return, and becoming easily located on major search engines may prove prohibitively time consuming or expensive. As a result, an Internet user searching for pertinent community information may potentially have to examine dozens of pages of search results before locating the desired information.

### BRIEF DESCRIPTION OF THE DRAWINGS

FIG. 1 is a block diagram depicting an exemplary Internet Protocol Television (IPTV) system;

FIG. 2 is a block diagram depicting an exemplary system including an IPTV network interface and a public data network interface;

FIG. 3 is a block diagram depicting an exemplary system including a set top box in accordance with an embodiment;

FIG. 4 is a flow chart depicting an illustrative method of sharing content;

FIG. 5 is a flow chart depicting an illustrative method of sharing content including a digital image;

FIG. 6 is a flow chart depicting an illustrative method of sharing content including a video stream;

FIG. 7 is a flow chart depicting an illustrative method of sharing content associated with a video dating channel;

FIG. 8 is a flow chart depicting an illustrative method of processing user ratings of video content;

FIG. 9 is an illustration depicting a user interface; and

FIG. 10 is a diagram of an embodiment of a general computer system.

### DETAILED DESCRIPTION OF THE DRAWINGS

The present disclosure is directed to a system and method for providing community content. The method can include making content received from a first user via a data network available to a second user via a video distribution service. The system can include a selective transmission and filtering module to control transmission of content between an interface to a public data network and a private video distribution system.

In one embodiment, a method of sharing content is disclosed. The method includes receiving content from a first user of a video distribution service via a data network, receiving an identification of a second user of the video distribution service authorized to access the content, and updating a channel map of the video distribution service to provide the second user with access to the content.

In another embodiment, a system is disclosed. The system includes a first network interface to a private video distribution system and a second network interface to a public data network having access to content that identifies a sender and an intended recipient that has access to the private video distribution system. The system also includes an authorization module to verify the sender is authorized to provide the content to the intended recipient via the private video distribution system. The system also includes a selective transmission and filtering module to transmit the content to the private video distribution system via the first network interface when the sender is authorized to provide the content to the intended recipient via the private video distribution system and to prevent transmission of the content to the private video distribution system via the first network interface when the sender is not authorized to provide the content to the intended recipient via the private video distribution system.

In another embodiment, a set-top box device is disclosed. The set-top box device includes a network interface to communicate with a private video distribution network, a display interface to communicate with a display device, and a buffer module to receive video content from the private video distribution network. The device further includes a user identification module to identify a user of the set-top box device, where the user is a member of a first community of the private video distribution network. The device includes a coder-decoder module to decode the video content received from the private video distribution network prior to transmitting the video content to the display device. The device includes an indicator module to transmit an indicator of community content received from the private video distribution network to the display device, where the community content is received at the private video distribution network from a member of the first community via a public network. The device further includes a content acquisition module to receive a selection of the indicator and to retrieve the community content associated with the indicator.

In another embodiment, a set of processor instructions embedded in a processor-readable medium is disclosed. The set of processor instructions includes instructions to receive a first rating from a first user of a television system for first video content, instructions to receive a second rating from the first user for second video content, and instructions to modify a user preference correlation between the first video content and the second video content when the first rating is favorable and the second rating is favorable.

In another embodiment, a user interface is disclosed. The user interface includes a viewing region to display video content from an internet protocol television (IPTV) system, where the video content corresponds to a first channel of the IPTV system, and where the IPTV system supports a plurality of communities. The user interface also includes a first indicator to indicate an availability of community content from the IPTV system, where the community content is available on demand from a second channel of the IPTV system. The community content is provided to the IPTV system by a plurality of members of a first community via the Internet.

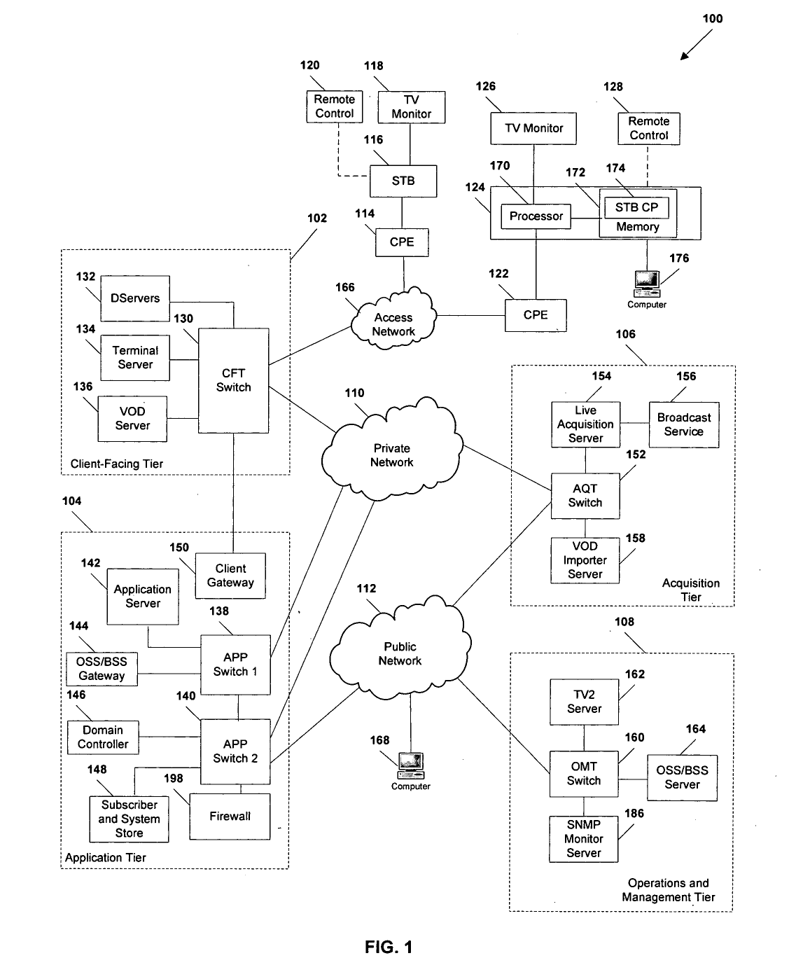

Referring to FIG. 1, an illustrative embodiment of an Internet Protocol Television (IPTV) system that may be used to share community content is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 at a first customer premise via the first CPE 114 and with a second representative set-top box device 124 at a second customer premise via the second CPE 122. The CPE 114, 122 can include routers, local area network devices, modems, such as digital subscriber line (DSL) modems, any other suitable devices for facilitating communication between a set-top box device and the access network 166, or any combination thereof.

In a particular embodiment, the client-facing tier 102 can be coupled to the CPE 114, 122 via fiber optic cables. Alternatively, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a set-top box (STB) processor 170 and a STB memory device 172 that is accessible to the STB processor 170. In one embodiment, a computer program, such as the STB computer program 174, can be embedded within the STB memory device 172. In another illustrative embodiment, a user computing device 176, such as a personal computer, laptop or local server, can be coupled to a set-top box device, such as the second representative set-top box device 124, for example, via a universal serial bus (USB) connection or other connection.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100.

In an illustrative embodiment, the client-facing tier 102 can communicate with a large number of set-top boxes, such as the representative set-top boxes 116, 124 over a wide geographic area, such as a regional area, a metropolitan area, a viewing area, a designated market area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that feeds one or more video streams from a video server to multiple set-top box devices.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

The second APP switch 140 can be coupled to a domain controller 146 that provides Internet access, for example, to users at their computers 168 via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. The second APP switch 140 can be coupled to a firewall 198 to selectively transmit and filter data from the public network 112 to the IPTV system 100 including the private network 110 and the private access network 166.

301 In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication to the set-top box devices 116, 124. The CFT switch 130 can communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162. For example, a user can access the TV2 server 162 using a personal computer (PC) 168 coupled to the public network 112.

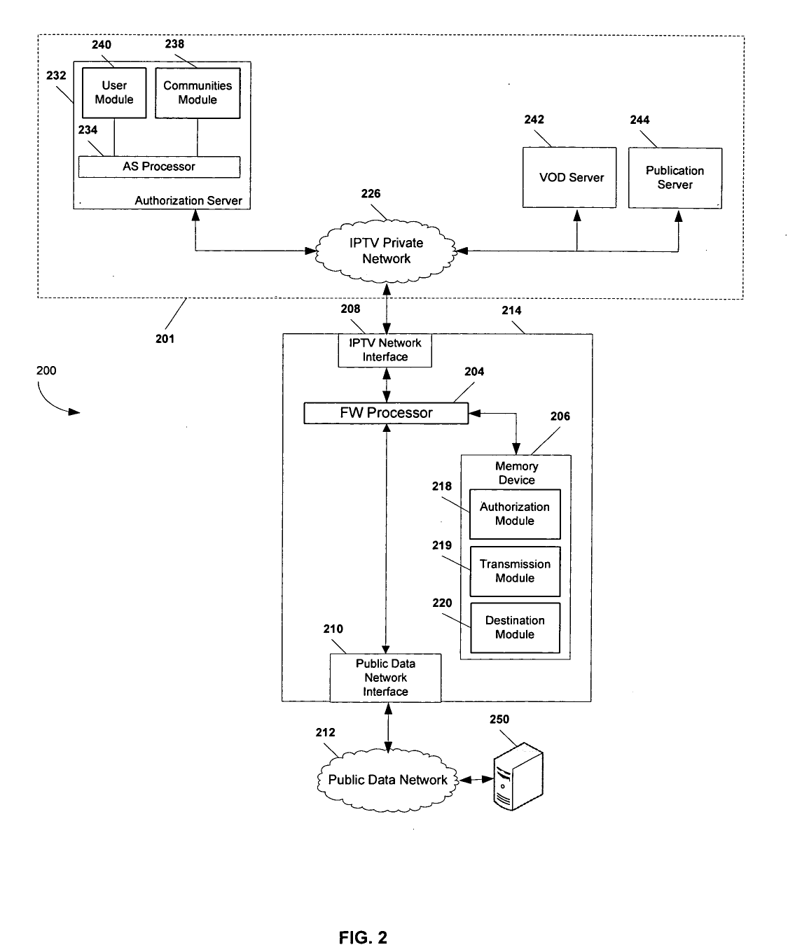

Referring to FIG. 2, a particular embodiment of a system is shown and generally designated 200. The system 200 includes a private video distribution system 201, depicted in FIG. 2 as an IPTV system that includes an authorization server 232, a video-on-demand server 242, and a publication server 244 in communication with an IPTV private network 226. A device 214 communicates with the private video distribution system 201 via a first network interface 208 accessible to the private network 226. The device 214 further communicates with a public data network 212 via a second network interface 210. A computer 250 may communicate with the public data network 212. The computer 250 may generate, store, format and send content that designates a sender having access to the public data network 212 and an intended recipient that has access to the private video distribution system 201 via private network 226.

The device 214 has a processor 204 which is coupled to the first network interface 208 and further coupled to the second network interface 210. The processor 204 is also coupled to a memory device 206. The device 214 includes an authorization module 218 to determine when a content sender is authorized to transmit content to an intended recipient via the private video distribution system 201. The device 214 also includes a transmission module 219 to selectively transmit and filter content to the private video distribution system 201 in response to the sender having authority to transmit to the private video distribution system 201. The device 214 further includes a destination module 220 to determine a destination of received content within the private video distribution system 201.

In operation, content that identifies a sender and an intended recipient is received at the public data network interface 210 from the public data network 212. The authorization module 218 of the device 214 verifies that the sender of the content is authorized to provide the content to the intended recipient via the private video distribution system 201. The selective transmission and filtering module 220 transmits the content to the private video distribution system 201 via the first network interface 208 when the sender is authorized to provide the content to the intended recipient. Likewise, the transmission module 219 prevents the transmission of the content to the private video distribution system 201 via the private video distribution system interface 208 when the sender is not authorized to provide the content to the intended recipient.

In a particular embodiment, the transmission module 219 may communicate with the destination module 220 to determine the destination in the private video distribution system 201 for transmission of the content. For example, the video content may be transmitted to the video-on-demand server 242. As another example, the content may be transmitted to the publication server 244 for transmission to a set-top box of the recipient. As yet another example, the content may be transmitted to both the video-on-demand server 242 and the publication server 244.

In a particular embodiment, the authorization module 218 of the device 214 may receive authorization information from the private video distribution system 201. For example, in the particular embodiment depicted in FIG. 2, the authorization module 218 can communicate with the authorization sever 232 of the private video distribution system 201. The authorization server 232 includes a processor 234 in communication with a user module 240 that identifies users having access to the private video distribution system 201. The processor 234 is also in communication with a communities module 238 that identifies communities of users of the private video distribution system 201. The authorization server 232 can access the user module 240 and the communities module 238 to determine authorization information for the authorization module 218 of the device 214. The authorization server 232 may transmit the authorization information to the device 214 via the private network 226.

In a particular embodiment, the content that is transmitted from the public data network 212 to the device 214 may indicate a sender that is a member of a first community, and may designate the first community as the intended recipient. The authorization server 232 may query the communities module 238 to determine if the sender is a member of the first community. When the sender is determined to be a member of the first community, the authorization sever 232 may verify the sender has authority to transmit the content to the private video distribution system 201. Thus, any member of a community of the private video distribution system 201 may be authorized to upload content via the public data network 212, such as the Internet, for viewing by other members of the community to which the sender belongs.

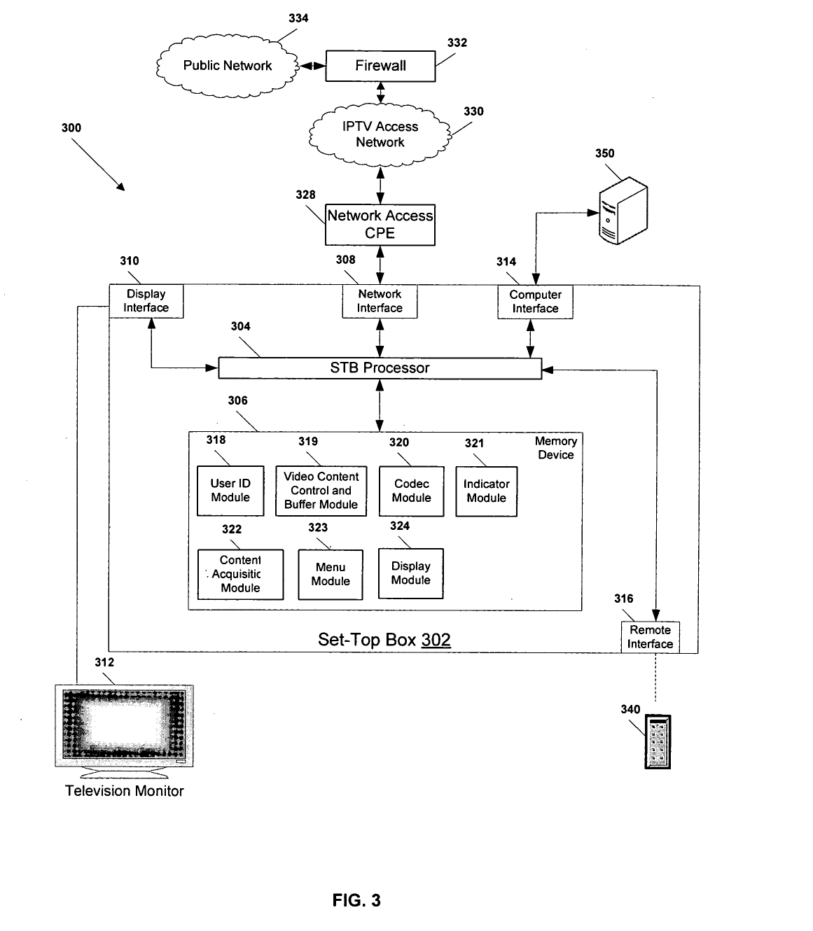

Referring to FIG. 3, a system is depicted in accordance with an embodiment and generally designated 300. The system 300 includes a public network 334 coupled to a private network 330 via a firewall 332. In the embodiment depicted in FIG. 3, the public network 334 may be the Internet, and the private network 330 may be an IPTV access network. The firewall 332 may be any device operable to selectively transmit content between the public network 334 and the IPTV access network 330 when a sender is authorized to transmit content to the recipient via the IPTV network 330.

The IPTV access network 330 is coupled to a representative set-top box 302 via customer premise equipment (CPE) 328. The set-top box 302 includes a processor 304 and a memory device 306 accessible to the processor 304. The set-top box 302 also includes a display interface 310 coupled to a display device such as a television monitor 312. The set-top box 302 includes a network interface 308 to communicate with the IPTV network 330 via CPE 328 and can further include a computer interface 314 to communicate with a computer 350 and a remote interface 316 to communicate with a remote control device 340. A buffer module 319 is operable to receive video content from the IPTV network 330 and a coder-decoder (CODEC) module 320 is operable to decode the video content prior to transmitting the video content to the display device 312.

A user identification module 318 can identify a user of the set-top box device 302. An indicator module 321 of the set top box 302 can transmit an indicator of community content received from the IPTV network 330 to the display device 312 when the user of the set-top box 302 is a member of a same community of IPTV users as the sender of the community content. A content acquisition module 322 of the set-top box 302 can receive the user's selection of an indicator of the community content and retrieve the community content associated with the indicator from the IPTV network 330. A menu module 323 can send a selectable menu of available community content to display on the display device 312.

In operation, a user of the set-top box 302 may belong to at least one community of an IPTV system that includes the IPTV network 330. When a second user of the IPTV system provides content from the public network 334 to the IPTV network 330, the second user may designate the first user as an intended recipient of the content, or may designate a community to which the first user belongs as an intended recipient, or any combination thereof. Upon determining an availability of community content, the indicator module 321 can display an indication on the display device 312 to indicate the availability of community content. The user of the set-top box 302 may select to view the community content such as by selecting a menu item with the remote control device 340. The content acquisition module 322 receives the user menu selection and retrieves the selected community content from the IPTV network 330 via network interface 308.

Various types of content may be provided to the IPTV system by community members. In a particular embodiment, the community content may include a video stream, a digital picture, an avatar, a user rating, or any combination thereof. In another particular embodiment, the community content includes a video stream, and the display module 324 of the set-top box 302 displays both the video stream and the video content received from IPTV network 330 at the television monitor 312 concurrently. For example, if the video content received from the IPTV access network 330 is a football game, the community content video stream may be an output from a friend's web-enabled video camera. The set-top box 302 may concurrently display at the display device 312 the video stream and the football game, such as a picture-in-picture display, so that the user may simulate an experience of watching the game with a friend.

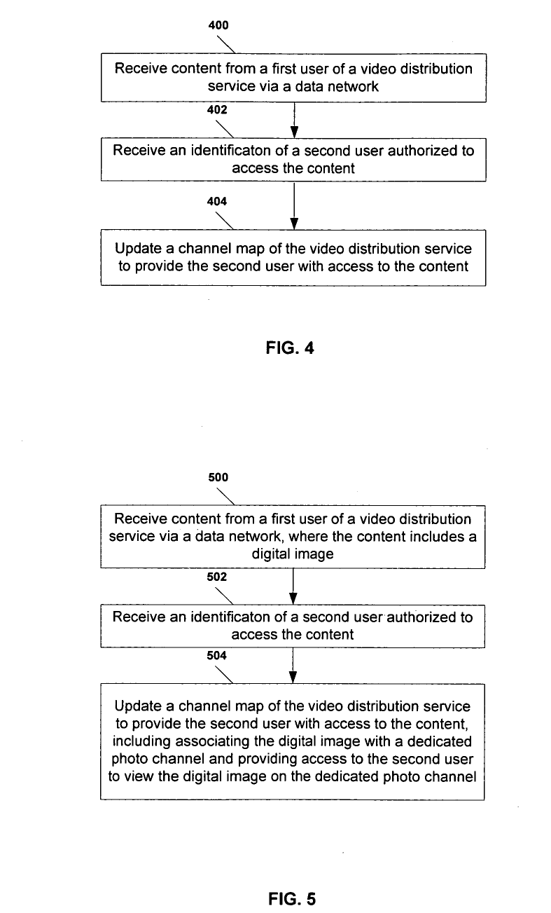

Referring to FIG. 4, a embodiment of a method of sharing content is shown. The method includes receiving content from a first user of a video distribution service via a data network at 400. As a non-limiting, illustrative example, the first user of a video distribution service may be a user of computer 168 as depicted in FIG. 1, the video distribution service may be the IPTV system 100 depicted in FIG. 1, and the data network may be the public network 112, such as the Internet.

The method continues at 402 with receiving an identification of a second user authorized to access the content. A channel map of the video distribution service is updated to provide the second user with access to the content at 404. As an illustrative example, the OSS/BSS server 164 depicted in FIG. 1 may validate authorized users to transmit content to the IPTV system 100, and further validate authorized users to receive the content via the IPTV system 100 and the access network 166. Upon authorizing the sender and the recipient, the OSS/BSS server 164 may update the channel map of the recipient so that the recipient may access the content by tuning to a channel associated with the content. The content may be stored, for example, in the video-on-demand server 136, or the D-server 132, or any combination thereof.

In a particular example, the second user may be a member of a community that has multiple members that use a video distribution service such as IPTV system 100 depicted in FIG. 1. The identification of the second user at block 402 may include an identification of the community, so that all members of the community may have access to the content. Although community content may be provided by sources other than community members, such as via the live acquisition server 154 of FIG. 1, at least a majority of the content associated with the television channel may be provided by members of the community. The television channel may therefore function as a portal to content provided by members of the community and further accessible to members of the community.

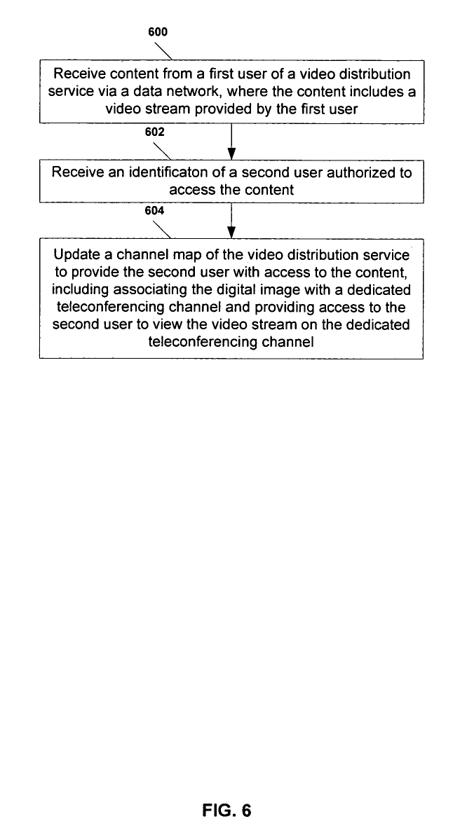

Referring to FIG. 5, a method of sharing content is depicted in accordance with a particular embodiment. The method begins with receiving content including a digital image from a first user of a video distribution service via a data network at 500. Continuing to 502, an identification of a second user authorized to access the content is received. At 504, the method continues with updating a channel map of the video distribution service to provide the second user with access to the content, including associating the image with a dedicated photo channel and providing access to the second user to view the digital image on the dedicated photo channel.

Referring to FIG. 6, a method of sharing content is depicted in accordance with a particular embodiment. The method begins with receiving content from a first user of a video distribution service via a data network, where the content includes a video stream provided by the first user at 600. The method continues with receiving an identification of a second user authorized to access the content at 602. Proceeding to 604, a channel map of the video distribution service is updated to provide the second user with access to the content, including associating the digital image with a dedicated teleconferencing channel, and providing access to the second user to view the video stream on the dedicated teleconferencing channel.

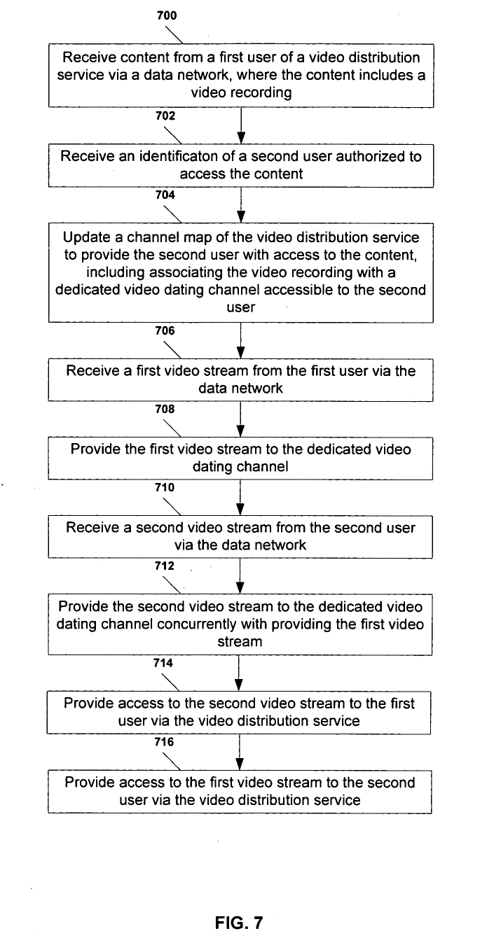

Referring to FIG. 7, a method of sharing content is depicted in accordance with a particular embodiment. The method begins at 700 with receiving content from a first user of a video distribution service via a data network, where the content includes a video recording. The method continues at 702 with receiving an identification of a second user authorized to access the content. Continuing at 704, a channel map of the video distribution service is updated to provide the second user with access to the content, including associating the video recording with a dedicated video dating channel accessible to the second user.

As an illustrative, non-limiting example, the content may be received via the public network 112 from a first user using the computer 168 of FIG. 1. The video distribution service may be the IPTV system 100, and the video recording may be stored at video-on-demand server 136. The terminal server 134 may execute a video dating application transmitted via the CFT switch 130 and the access network 166 to the set-top box 124 of a second user for display on the TV monitor 126. The second user may tune the set-top box 124 to the dedicated video dating channel as designated on the second user's channel map and authorized by the OSS/BSS server 164.

In accordance with another embodiment, the method continues at 706, where a first video stream from the first user is received by the data network. The first video stream is then provided to the dedicated video dating channel at 708. Continuing at 710, a second video stream is received from the second user via the data network. The second video stream is provided to the dedicated video dating channel concurrently with providing the first video stream at 712, and access to the second video stream is provided to the first user by the video distribution service at 714. Access to the first video stream is provided to the second user via the video distribution service at 716.

As an illustrative, non-limiting example, the second user may be a viewer of TV monitor 126 that tunes the set-top box 124 to a dedicated video dating channel of the IPTV system 100 of FIG. 1. The second user, after viewing the video recording received from the first user via the dedicated video dating channel, may then initiate an upload of a video stream, such as the output of a web-enabled video camera (not shown) via a second computer (not shown) connected to the public network 112. After the OSS/BSS server 164 determines the second user is authorized to upload video content to the IPTV system 100, the video stream may be transmitted to the D-server 132 for formatting and made available for access by the first user via the dedicated video dating channel. Upon receiving an indication of the availability of the video stream from the second user, the first user may also decide to upload a video stream via the computer 168 to the IPTV network 100. The uploaded video stream may also be delivered to the D-server 132 and formatted for transmission to the second user via the dedicated video dating channel. Thus, after watching the video recording, the sender and a recipient may initiate a two-way video teleconferencing session via the dedicated video dating channel.

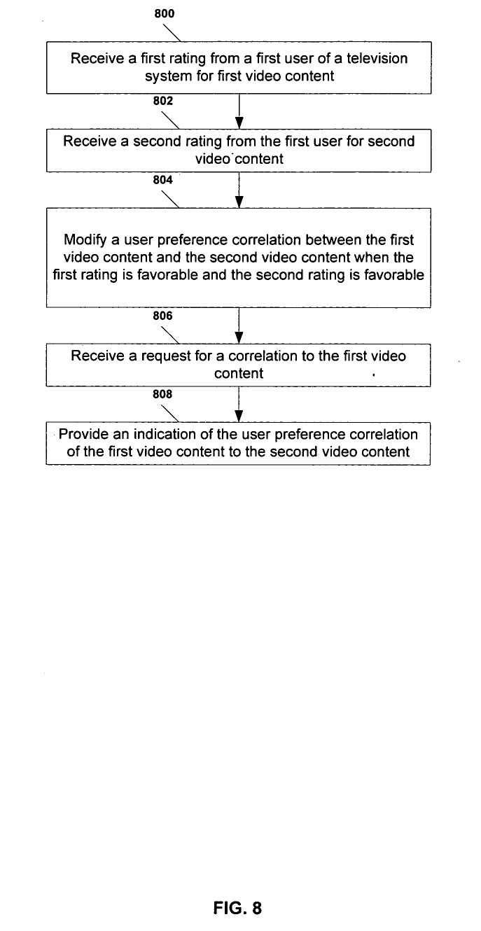

Referring to FIG. 8, an embodiment of a method of processing user ratings of video content is depicted. The method begins at 800 with receiving a first rating from a first user of a television system for first video content. The method continues with receiving a second rating from the first user for second video content at 802. A user preference correlation between the first video content and the second video content is modified when the first rating is favorable and the second rating is favorable at 804. At 806, a request for a correlation to the first video content is received, and an indication of the user preference correlation of the first video content to the second video content is provided at 808.

As an illustrative, non-limiting example, the method depicted in FIG. 8 may be practiced on the IPTV system 100 depicted in FIG. 1. The OSS/BSS server 164 may maintain a user preference correlation between the first video content, such as a first television program, and the second video content, such as a second television program. When a user of the IPTV system 100, such as a user of monitor 126 and set-top box 124, provides a first rating for the first television program and a second rating from the second television program, a user preference correlation that may be stored in the OSS/BSS server 164 may be modified to demonstrate a stronger correlation between a favorable rating of the first television program and a favorable rating of the second television program. The updated user preference correlation may remain stored at the OSS/BSS server 164 and further updated by additional ratings provided by other users of the IPTV system 100. Upon receiving the request for a correlation to first television program, the OSS/BSS server 164 may provide the requestor with an indication that the second television program has a strong user preference correlation to the first video content.

Thus, when a user viewing the first television program desires to see a second television program that was enjoyed by other viewers enjoying the first program, the user may request a second television program that has strongly correlated user ratings to the first television show. In a particular embodiment, an IPTV system having multiple communities may also store multiple community-specific user preference correlations. As an illustrative example, one community may strongly correlate “The Simpsons” to “Dora the Explorer,” while another community may strongly correlate “The Simpsons” to “Married with Children.” A user may thus request and receive a user preference correlation corresponding to one or more communities the user belongs to. It should be understood that the request need not be a request initiated by a user of an IPTV system, and may instead be a request initiated, for example, by a computer program executed on a set-top box, a terminal server, an application server, or any other source that is authorized to receive the user preference correlation, or any combination thereof.

Futhermore, the request for the user preference correlation need not originate within the television system. In a particular embodiment, the first rating and the second rating are received from the first user of an IPTV system via a public network, while the indication of the user preference correlation may be provided to a set-top box of a second user via a private video distribution system to display on a display device coupled to the set-top box. For example, the indication of the user preference may be transmitted to set-top box 124 of IPTV system 100 depicted in FIG. 1, for display on television monitor 126.

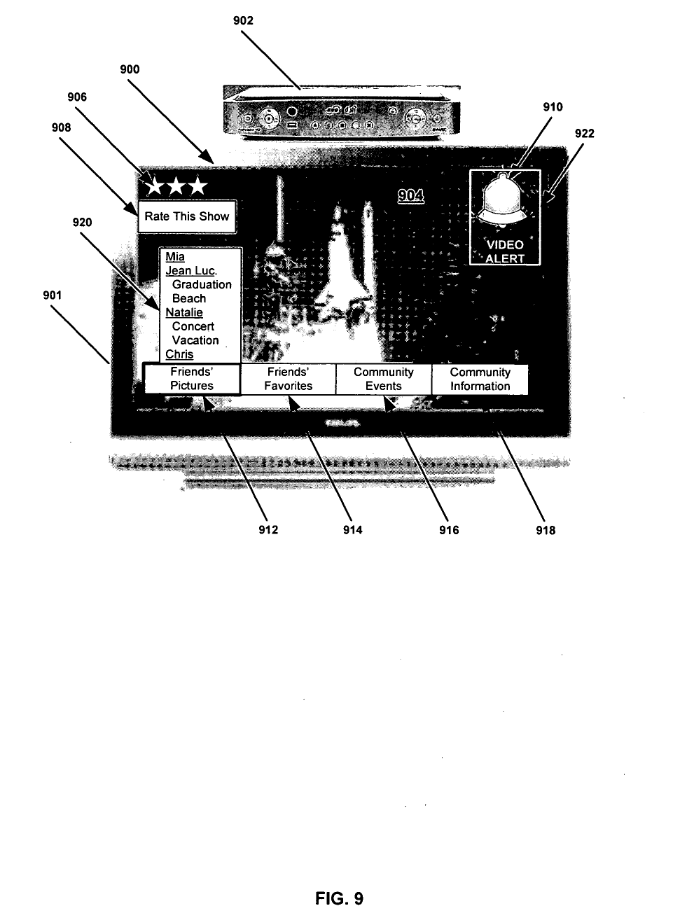

Referring to FIG. 9, an embodiment of a user interface 900 is depicted on a display device 901. The display device 901 can be coupled to an IPTV system via a set-top box 902. The user interface 900 includes a viewing region 904 to display video content corresponding to a first channel from the IPTV system. The user interface 900 further includes an indicator 906 of availability of community content from the IPTV system that is available on demand from a second channel of the IPTV system. The community content may be provided to the IPTV system by multiple members of a first IPTV community via the Internet.

For example, the indicator 906 displays a star rating that indicates a user rating provided by members of the community to which a user of the user interface 900 belongs. A selection region 908 corresponds to the user rating indicator 906. The selection region 908 can receive a selection to rate the video content displayed in display region 904.

Additional indicators of community content available via the IPTV system include an indicator of Friends' Pictures 912, an indicator of Friends' Favorites 914, an indicator of Community Events 916, and an indicator of Community Information 918. The indicators 912, 914, 916 and 918 each have a corresponding selection region depicted as a border around each indicator. For example, the selection region corresponding to the Friends' Pictures indicator 912 is shown highlighted as a thick border around the indicator 912.

A user selection of one of the indicators of community content may result in a secondary menu being displayed such as the menu of 920 of the interface 900. The secondary menu 920 lists available pictures provided by members of the community that have designated the user of the interface 900 as an intended recipient. Although the secondary menu 920 lists community content specifically indicating the user of the interface 900 as an intended recipient, other indicators such as the Community Events indicator 916, may indicate community content accessible by all members of the community. For example, the indicator 916 may indicate a video recording of a city council meeting that may be available to all members of the community. As another example, the indicator 918 may indicate data relating to school activities that may also be available to all members of the community.

The user interface 900 also includes an indicator 910 indicating the availability of a video stream to the user of the interface 900. A selection region 922 corresponds to the indicator 910 to receive the video stream content indicated by the indicator 910. The selection regions of the user interface 900 may be navigable and selectable via standard input device techniques such as remote control navigation and selection keys, as one illustrative, non-limiting example.

In an embodiment, the user interface 900 may include indicators that indicate an availability of content provided by a second user to the IPTV system via a public network. Where the second user is a member of the community to which the member of the IPTV system using user interface 900 belongs, and further when the second user designates the user of user interface 900 on a buddy list, then the indicator may indicate the availability of the content provided by the second user. As an illustrative example, the Friends' Favorites indicator 914 may indicate the availability of television shows or digital images which have been designated as favorites of community members that also have included the user of the user interface 900 on their respective buddy lists.

Although the indicator 910 is depicted and described as indicating an availability of a video stream provided by another user of the IPTV system via a public network, it should be understood that the indicator 910 need not indicate a video stream, and may instead indicate the availability of other community content which may be streamed or otherwise provided to display device 904 via set-top box 902. For example, the available content indicated by the indicator 910 may be one or more text messages associated with an instant messaging session.

Furthermore, although the embodiment of the user interface 900 of FIG. 9 is depicted having multiple indicators of community content, such as the indicators 906, 910, 912, 914, 916 and 918, it should be understood that the user interface 900 may have only one indicator of community content, or any number of indicators of community content. It should also be understood that a number of displayed indicators of community content may depend, for example, on a number of communities to which a user of the user interface 900 belongs. Additionally, communities may generally refer to a group of members that may be predominately distinguishable geographically, politically, ethnically, culturally, or the like, or any combination thereof. As another non-limiting, illustrative example, the availability and number of indicators of community content may be determined by a level of subscriber access to IPTV services, such as may be designated by the OSS/BSS server 164 of the IPTV system 100 of FIG. 1.

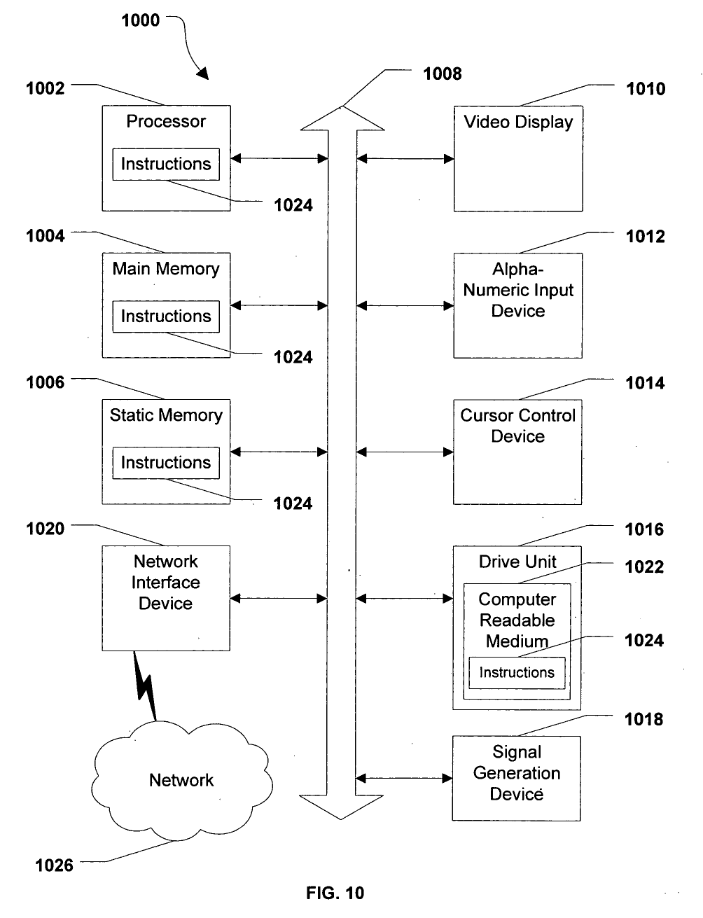

Referring to FIG. 10, an illustrative embodiment of a general computer system is shown and is designated 1000. The computer system 1000 can include a set of instructions that can be executed to cause the computer system 1000 to perform any one or more of the methods or computer based functions disclosed herein. The computer system 1000, or any portion thereof, may operate as a standalone device, such as the set-top box devices and domain controller shown in FIG. 1, or may be connected, e.g., using a public network or a private network within an IPTV system, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. Moreover; the computer system 1000 can include a main memory 1004 and a static memory 1006 that can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. Further, the computer system 1000 can include a wireless input device 1015, e.g., a remote control device. When the computer system 1000, or any portion thereof, is embodied in a set-top box device, the cursor control device 1014 can be a remote control device. The computer system 1000 can also include a disk drive unit 1016, a signal generation device 1018, such as a speaker or remote control, and a network interface device 1020.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In conjunction with the configuration of structure described herein, the systems and methods disclosed generally provide community content in conjunction with video distribution systems. The community content is selectable and can be displayed via an interactive user interface that is linked to a user's community. By enabling authorized users to provide content to the video distribution system, designated recipients such as community members may receive the content, such as by tuning to a dedicated community channel.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a first network interface to a private video distribution system;
a second network interface to a public data network having access to content that identifies a sender and an intended recipient that has access to the private video distribution system;
an authorization module to verify the sender is authorized to provide the content to the intended recipient via the private video distribution system; and
a selective transmission and filtering module to transmit the content to the private video distribution system via the first network interface when the sender is authorized to provide the content to the intended recipient via the private video distribution system and to prevent transmission of the content to the private video distribution system via the first network interface when the sender is not authorized to provide the content to the intended recipient via the private video distribution system.

2. The system of claim 1, wherein the authorization module is operable to receive authorization information from the private video distribution system.

3. The system of claim 2, wherein the intended recipient comprises a community having a plurality of members that use the private video distribution system, and wherein the sender is a member of the community.

4. The system of claim 2, further comprising a destination module to determine a destination of the content within the private video distribution system.

5. The system of claim 1, wherein the private video distribution system is an internet protocol television system.

6. A method of sharing content, comprising:
receiving content from a first user of a video distribution service via a data network;
receiving an identification of a second user of the video distribution service authorized to access the content; and
updating a channel map of the video distribution service to provide the second user with access to the content.

7. The method of claim 6, wherein updating the channel map includes associating the content with a television channel accessible to the second user.

8. The method of claim 6, wherein the second user is a member of a community, wherein the community has a plurality of members that use the video distribution service, wherein the identification of the second user includes an identification of the community, and wherein at least a majority of content associated with the television channel is provided by at least some of the plurality of members of the community.

9. The method of claim 6, wherein the content comprises a digital image, and wherein updating the channel map includes:
associating the digital image with a dedicated photo channel; and
providing access to the second user to view the digital image on the dedicated photo channel.

10. The method of claim 6, wherein the content comprises a video stream provided by the first user, and wherein updating the channel map includes:
associating the video stream with a dedicated teleconferencing channel; and
providing access to the second user to view the video stream on the dedicated teleconferencing channel.

11. The method of claim 6, wherein the content comprises a video recording, and wherein updating the channel map includes associating the video recording with a dedicated video dating channel accessible to the second user.

12. The method of claim 11, further comprising:
receiving a first video stream from the first user via the data network;
providing the first video stream to the dedicated video dating channel;
receiving a second video stream from the second user via the data network;
providing the second video stream to the dedicated video dating channel concurrently with providing the first video stream;
providing access to the second video stream to the first user via the video distribution service; and
providing access to the first video stream to the second user via the video distribution service.

13. A set top box device comprising:
a network interface to communicate with a private video distribution network;
a display interface to communicate with a display device;
a buffer module to receive video content from the private video distribution network;
a user identification module to identify a user of the set top box device, wherein the user is a member of a first community of the private video distribution network;
a coder-decoder module to decode the video content received from the private video distribution network prior to transmitting the video content to the display device;
an indicator module to transmit an indicator of community content received from the private video distribution network to the display device, wherein the community content is received at the private video distribution network from a member of the first community via a public network; and
a content acquisition module to receive a selection of the indicator and to retrieve the community content associated with the indicator.

14. The set top box device of claim 13, further comprising a menu module to send a selectable menu of available content to display on the display device.

15. The set top box device of claim 13, wherein the community content includes at least one of a video stream, a digital picture, an avatar, and a user rating.

16. The set top box device of claim 15, wherein the community content comprises a video stream, and further comprising a display module to transmit the video stream and the video content received from the private video distribution network to the display device to display concurrently.

17. A set of processor instructions embedded in a processor-readable medium, the set of processor instructions comprising:
instructions to receive a first rating from a first user of a television system for first video content;
instructions to receive a second rating from the first user for second video content; and
instructions to modify a user preference correlation between the first video content and the second video content when the first rating is favorable and the second rating is favorable.

18. The set of processor instructions of claim 17, wherein at least one of the first rating and the second rating is received from the first user via a public network, and wherein the set of processor instructions further comprises:
instructions to receive a request for a correlation to the first video content; and
instructions to provide an indication of the user preference correlation of the first video content to the second video content.

19. The set of processor instructions of claim 18, wherein the first video content is a first television program, wherein the second video content is a second television program, wherein the indication of the user preference correlation indicates that users that prefer the first television program also tend to prefer the second television program.

20. The set of processor instructions of claim 18, wherein the television system is an internet protocol television system.

21. The set of processor instructions of claim 20, wherein the first rating and the second rating are received from the first user via a public network, and wherein the instructions to provide the indication of the user preference correlation include instructions to provide the indication of the user preference correlation to a set top box of a second user via a private video distribution system to display on a display device coupled to the set top box.

22. A user interface comprising:
a viewing region to display video content from an internet protocol television (IPTV) system, wherein the video content corresponds to a first channel of the IPTV system, wherein the IPTV system supports a plurality of communities; and
a first indicator to indicate an availability of community content from the IPTV system, wherein the community content is available on demand from a second channel of the IPTV system, and wherein the community content is provided to the IPTV system by a plurality of members of a first community via the Internet.

23. The user interface of claim 22, wherein the first indicator indicates an availability of at least one of a video recording of a city counsel meeting and data relating to school activities.

24. The user interface of claim 22, further comprising:
a second indicator to indicate an availability of content provided by a second user to the IPTV system via a public network, wherein the second user is a member of the first community, wherein the first user is a member of a buddy list of the second user, and wherein the content provided by the second user includes at least one of an indication of a favorite show and a digital image; and
a second selection region to receive a selection to view the content provided by the second user.

25. The user interface of claim 22, further comprising:
a third indicator to indicate an availability of content provided by a third user to the IPTV system via the public network, wherein the third user is a member of the first community, and wherein the content provided by the third user includes at least one of a text message and a video stream; and
a third selection region to receive a selection to view the content provided by the third user.
